(19) United States
(12) Patent Application Publication
(10) Pub. No.: US 2013/0166415 A1
(43) Pub. Date: Jun. 27, 2013

(54) Adapting Mobile Catalogs by Filtering for Available Products, Mass Movers and Hot-Sellers

(71) Applicants: Jens Odenheimer, Karlsruhe (DE); Peter Eberlein, Malsch (DE)

(72) Inventors: Jens Odenheimer, Karlsruhe (DE); Peter Eberlein, Malsch (DE)

(21) Appl. No.: 13/334,030

(22) Filed: Dec. 21, 2011

(51) Int. Cl. G06Q 30/00

(52) U.S. Cl. 705/26.62

(57) ABSTRACT

Methods and apparatus, including computer program products, are provided generating catalogs for use on a mobile wireless device. The method may include sending, from a mobile wireless device, a request for available to promise information; receiving, at the mobile wireless device, the requested available to promise information; and presenting, based on the received available to promise information, at least one of a first product information and a second product information, the first product information representative of a first product having a sales volume exceeding a sales volume threshold, the second product information representative of a second product having a sales rate exceeding a sales rate threshold. Related apparatus, systems, methods, and articles are also described.

The subject matter described herein relates to generating electronic catalogs.

### BACKGROUND

Purchasing products from catalogs available in electronic form on the Internet has become commonplace today. Almost every type of website has products for sale in an electronic product catalog. For example, retailers may provide catalogs of products for sale. For example, a home improvement store may have an electronic catalog of home appliances, which would likely include appliances such as vacuums, stoves, refrigerators, and the like, that can be purchased over the Internet. Other examples include electronic catalogs of women's clothing, men's clothing, and kid's clothing. Users can select products that they wish to purchase from the catalog, pay for the products, and enter shipping information, as needed.

### SUMMARY

Methods and apparatus, including computer program products, are provided for generating electronic product catalogs. For some example implementations, there is provided a method. The method may include sending, from a mobile wireless device, a request for available to promise information; receiving, at the mobile wireless device, the available to promise information; and presenting, based on the received available to promise information, at least one of a first product information and a second product information, the first product information representative of a first product having a sales volume exceeding a sales volume threshold, the second product information representative of a second product having a sales rate exceeding a sales rate threshold.

In some implementations, the above-noted aspects may further include additional features described herein including one or more of the following. The receiving may further include updating available to promise information at the mobile wireless device, wherein a time interval between a first update and a second update is based on a quantity of available stock and a sales rate. The first product may comprise a mass mover, and the second product may comprises a hot seller. The mass mover may be determined by selecting products with the sales volume greater than the sales volume threshold. The hot seller may be determined by selecting products with the sales rate greater than the sales rate threshold. The received available to promise information comprises information about one or more products, the information including one or more of the following: a number of items in stock for each of the one or more products, a pricing for the one or more products, an availability of the one or more products, a past order for the one or more products, and a pending order for the one or more products.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a simplified functional block diagram of an exemplary system in accordance with some exemplary implementations;

FIG. 2 depicts an example of a page presented at a user interface in accordance with some exemplary implementations;

FIG. 3 depicts another example of a page presented at a user interface in accordance with some exemplary implementations;

FIG. 4 depicts an example used to show adjustment to an update interval in accordance with some exemplary implementations;

FIG. 5 depicts an example used to show mass movers and hot sellers in accordance with some exemplary implementations;

FIG. 6 depicts an example of a process using and adjusting the time interval between available stock updates and using mass movers and hot sellers in accordance with some exemplary implementations; and

FIG. 7 depicts another example of a process associated with available to promise, hot sellers, and mass movers in accordance with some exemplary implementations.

Like labels are used to refer to same or similar items in the drawings.

### DETAILED DESCRIPTION

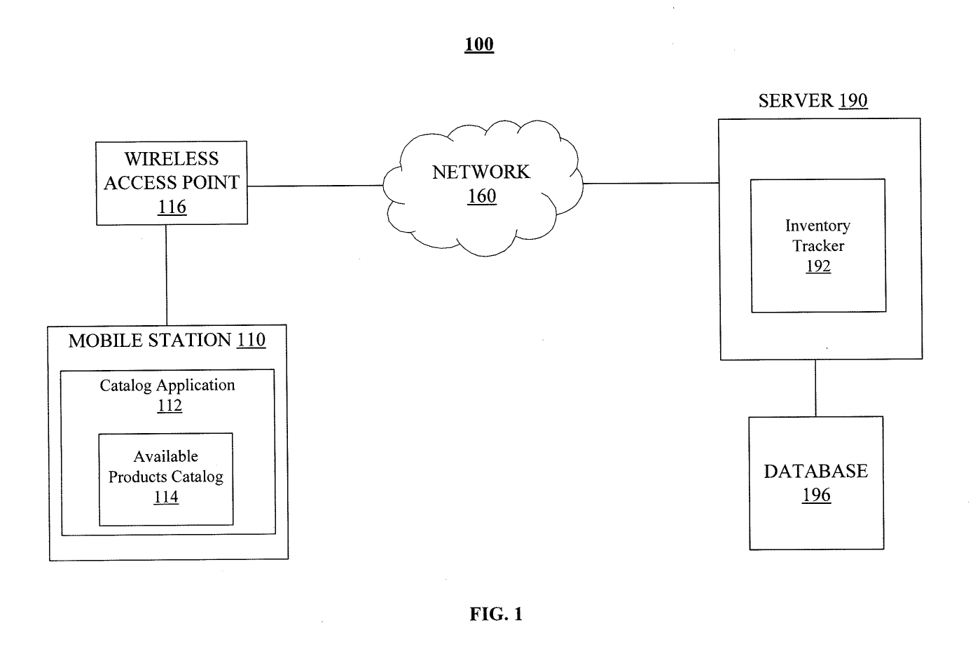

FIG. 1 depicts a system 100 for generating an available products catalog 114 in accordance with some exemplary implementations. The system 100 may include at least one server, such as for example server 190, coupled to a network, such as network 160, which in turn is coupled to mobile station 110 via wireless access point 116.

The server 190 may comprise a computer system with a wired or wireless interface to network 160 and in some implementations an interface to database 196. The computer system may comprise at least one processor, at least one memory, and the like. In some implementations, the server 190 may be configured on a virtual machine hosted on a physical processor. The server 190 may further include an inventory tracker 192 for tracking product inventory information and may be coupled to database 196, where inventory information may be stored. The inventory information stored in database 196 may include one or more of the following: a plurality of products which may be queried by inventory tracker 192 for inclusion in a catalog, pricing for the plurality of products, availability of the plurality of products, past orders for the plurality of products, pending orders for the plurality of products, and the like.

The inventory tracker 192 may perform one or more of the following: generate a catalog of one or more products whether or not they are available to promise to a customer; receive from catalog application 112 a request for an update to the one or more products that are available to promise to a customer, the quantity available of the one or more products and a timestamp indicating the time when the update was performed; and/or query database 196 for products to include in the catalog of products whether or not they are available. For example, a product that is in stock and ready to be shipped or delivered is considered a product that is available to promise. Although the examples herein refer to products, services may also be included in the available products catalog 114 as well.

Network 160 may include any type of wired network, wireless network, or combination of the two. For example, network 160 may comprise one or more of the following: a public switched telephone network (PSTN), the Internet, a public land mobile network (PLMN), and the like.

The wireless access point 116 may provide wireless access to a public land mobile network and/or a wireless local area network. For example, the wireless access point 116 may be implemented as a cellular base station of a public land mobile network and/or as a wireless access device (e.g., a Wi-Fi wireless access point) providing access to a wireless network.

The mobile station 110 may be implemented as a mobile wireless device, although at any given time the mobile station may be stationary. The mobile station may be referred to as, for example, a device, a user equipment, a mobile unit, a subscriber station, a wireless terminal, a terminal, a tablet, a netbook computer, a laptop computer and/or any other wireless device. Moreover, the mobile station may also be implemented as, for example, a wireless handheld device, a wireless plug-in accessory, or the like. For example, the mobile station may take the form of a wireless phone, a computer with a wireless connection to a network, or the like. In some instances, the mobile station may include one or more of the following: at least one processor, at least one computer-readable storage medium (e.g., memory, storage, and the like), at least one user interface, and at least one radio access mechanism.

The mobile station 110 may further include a catalog application 112. The catalog application 112 may include a catalog of one or more products whether or not they are available to promise to a customer, a web browser, a thin client, and/or any other mechanisms for presenting the available products catalog 114 including pages depicting at least one of available products, mass movers, and hot sellers. The catalog application may be used to determine which products from the catalog of products are available to promise to a customer, and for determining products that are mass movers (e.g., have a high sales volume) and/or hot sellers, (e.g., are selling rapidly). In some implementations, to determine means to select or to filter. In other implementations, to determine may include calculations using current and past information from the inventory tracker 192 including stock information and time stamp information. Catalog application 112 further presents the products that are available to promise, mass movers, and/or hot sellers in available products catalog 114. For example, the available products catalog 114 may be presented as one or more pages, such as hypertext markup language pages, generated to allow a user to view the products that are available to promise, mass movers, and/or hot sellers. Catalog application 112 may determine at least the products that are available to promise, mass movers, and/or hot sellers.

As noted above, available products catalog 114 may be represented by one or more pages, such as hypertext markup language pages, generated to allow a user to view the products that are available to promise, mass movers, and/or hot sellers. In some implementations, only products that are available to promise are included in the available products catalog 114.

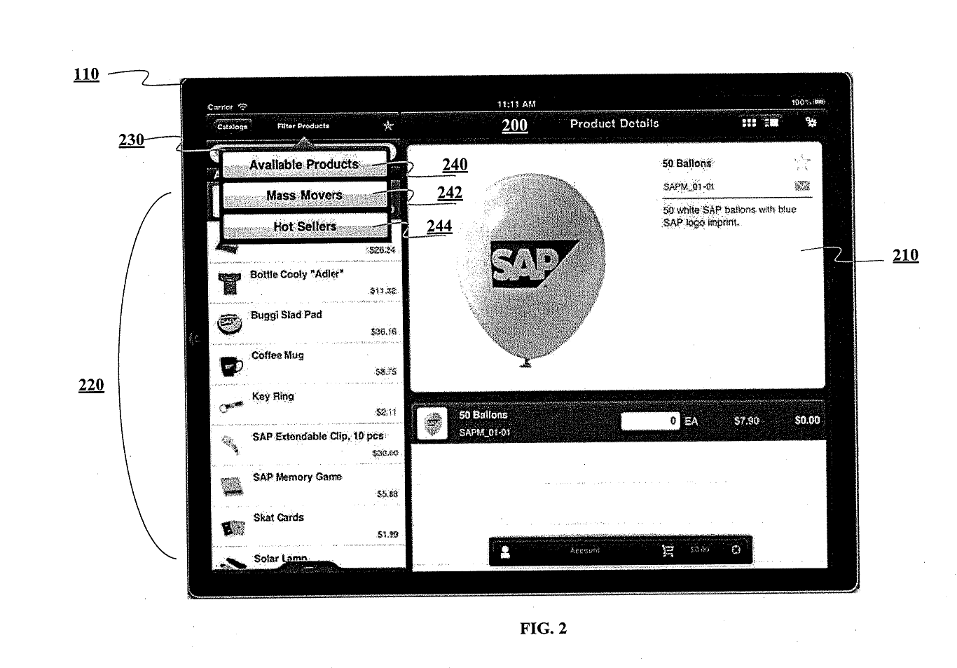

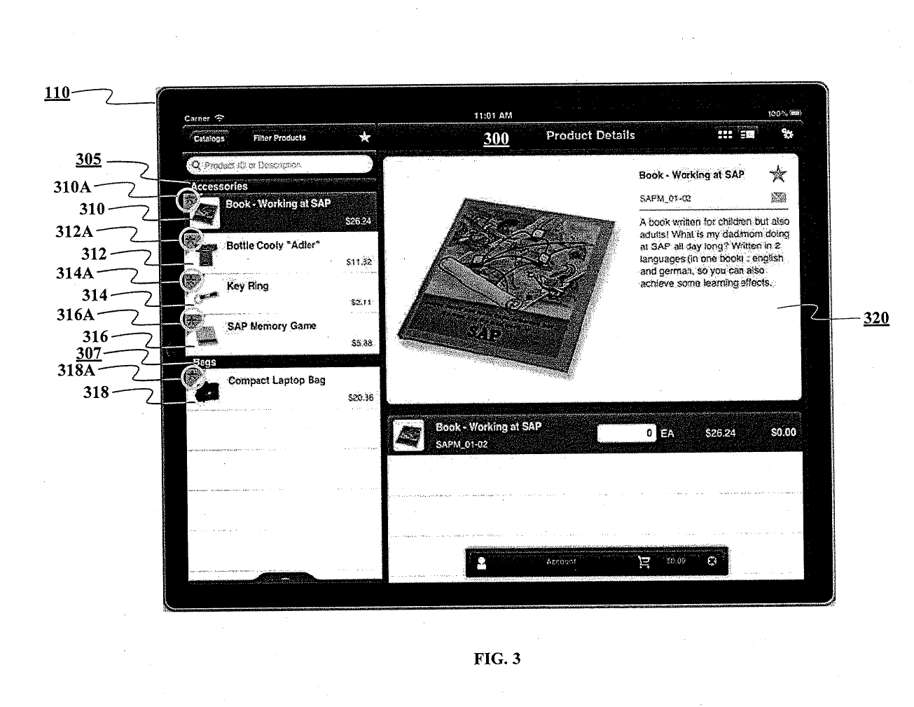

To illustrate further by way of an example, products A, B, and C are included in a catalog of products included in catalog application 112. Consider, for example, that products A and C have stock available to promise, but product B has no stock available to promise. In this example, only products A and C are included in available products catalog 114. Available products catalog 114 may be presented at user interface of mobile station 110 as one or more pages such as those shown in FIGS. 2 and 3. The pages may include the products available to promise, the mass movers, and/or the hot sellers. The one or more pages depicting the products of the available products catalog 114 may be configured as hypertext markup language pages, although other types of pages may be used as well.

The catalog application 112 may update the number of units of each product that is available to promise, and store the updates at catalog application 112 along with a timestamp of when the update occurred to enable the determination of available products, mass movers, and hot sellers. The catalog application 112 may perform an update periodically and automatically. For example, the updates may occur at a certain frequency. As the available stock fluctuates in successive updates, the frequency of these updates may be adjusted by catalog application 112. In some implementations, the update frequency is a time interval determined based on at least the stock available to promise and the sales rate of that product. For example, if the stock available of a particular product is low, the frequency of updates for that product may need to increase in order to track the available stock as the stock dwindles and to allow an accurate prediction of the time when the available stock will be exhausted. The catalog application 112 may request an update at any time (also referred to as on-demand). The catalog application 112 may determine the mass movers and hot sellers based on the change in the number of units available to promise in a series of updates and the associated time between updates (determined by the differences between the times of the time stamps).

In some implementations, a mass mover refers to a product with a high sales volume. For example, a product may be identified as a mass mover, when the number of units sold is larger than a threshold value. For example, if the number of units sold of a product A over two or more time stamped queries to the inventory tracker 192 is greater than a threshold value, product A may be a mass mover. The threshold value may be a predetermined value, e.g., a fixed value or a value that may be varied. For example, given a threshold of 1000 units, any product with sufficient stock that has sold 1000 units or more within a given timeframe would be considered a mass mover, and included in the available products catalog as a mass mover. Products selling fewer than 1000 units would not be considered mass movers. As an example of a variable threshold, the threshold for mass movers may be chosen to be a given quantity of units greater than an average number of units sold. For example, if the average number of units sold was 800 and the variable threshold was set at 500 units over the average number of units sold, then any product that sold 1300 units or more would be considered a mass mover. If at another time, the average number of units sold was 1200 and the variable threshold was 500 units over the average, to be considered a mass mover a product would have to sell 1700 units or more to be considered a mass mover. The previous examples are merely examples as other thresholds and other processes may be used to determine the thresholds for the mass movers. Moreover, different products may have different threshold values for determining (e.g., selecting) whether a product is a mass mover or not. In some implementations, the threshold value for a product or group of products may be set by user input. In other implementations, the threshold value for each product or a group of products may be included in the catalog of products. In other implementations, the threshold may be determined by catalog application 112 by comparing the number of units sold of each product in the available products catalog 114 to the other products in the catalog and selecting a predetermined number of products with the highest sales volumes as the mass movers. In this way whether a product is a mass mover and thus included in available products catalog 114 as a mass mover may be determined by, for example, the threshold described above, although the mass mover may, in some implementations, be determined without the use of a threshold as well.

The hot seller refers to a product having a high sales rate. For example, a product may be identified as a hot seller, when the sales rate is greater than a threshold number of units sold over a given time period. The sales rate threshold may be a predetermined value or a value that is variable. As an example of a predetermined sales rate threshold value, the rate of units sold may be 50 units per hour. In this example, if product A sold 10 units per hour and product B sold 100 units per hour, then product B would be considered a hot seller, and included in the available products catalog 114 as a hot seller since the sales rate of product B exceeds the threshold value. Because the sales rate of product A does not exceed the sales rate threshold value, it would not be considered a hot seller. As an example of a variable sales rate threshold value, the sales rate threshold value for hot sellers may be a sales rate that exceeds the average sales rate by some number of units per unit time. If, for example, the average sales rate was 18 units per day and the sales rate threshold value was set to 50 units per day over the average, then any product that sold 68 units per day or greater would be considered a hot seller, and therefore included in the available products catalog 114 as a hot seller. Products that had a sales rate below the variable sales rate threshold would not be included as a hot seller. Although specific examples are described above, these are merely examples as other sales rate thresholds and other processes may be used as well to determine the sales rate thresholds for the hot sellers. In some implementations, the threshold value for a product or group of products may be set by user input. In other implementations, the threshold value for each product or a group of products may be included in the catalog of products. In other implementations, the threshold may be determined by catalog application 112 by comparing the sales rate of each product in the available products catalog 114 to the other products in the catalog and selecting a predetermined number of products with the highest sales rates as the hot sellers.

In some implementations, the sales rate threshold may be determined based on a specific number of units over a specific time period. For example, a sales rate threshold of product A may be 50 units per 2 hours. Product B may be selling 25 units per hour, and thus has the same sales rate per hour as product A but over a different time period. In some implementations, this disparity is corrected by using a specific time period to determine the sales rate. For example, if the specific time period is set as 2 hours, product A would be considered a hot seller, but product B would not be considered a hot seller. In this way whether a product is a hot seller may be determined by, for example, the sales rate threshold described above, although the sales rate threshold may in some implementations be determined without the use of a threshold as well.

In some implementations, one or more pages including one or more products of the available products catalog 114 may be presented by catalog application 112 at a user interface of mobile station 110.

In some implementations, the inventory tracker 192 may include catalog application 112. The inventory tracker 192 may also generate one or more pages depicting available products catalog 114, including pages depicting at least one of available products, mass movers, and/or hot sellers. The inventory tracker 192 may also send the generated pages to mobile station 110 to be presented at a user interface of mobile station 110.

FIG. 2 depicts a page 200 and pop-up window 230 presented at a user interface of mobile station 110. The description of FIG. 2 also refers to FIG. 1. Page 200 depicts products 220 which are available (also referred to herein as available to promise) and product details 210.

The page 200 includes available products 220, and product descriptions 210. Pop-up window 230 allows selection of available products, mass movers, or hot sellers, generated by catalog application 112. Page 200 depicted in FIG. 2 shows a page representing the results after selecting available products 240 in window 230. Upon selecting available products 240 in window 230, information of the selection is sent to catalog application 112, which generates available products catalog 114 and the page 200 showing the available products.

For example, when a user selects available products 240 in pop-up window 230, the selection is sent to the catalog application 112, which determines the available products catalog 114 by filtering out products in the product catalog that do not have stock that is available to promise to a customer. Next, a representation of the available products catalog is sent as a page to a web browser, thin client, and/or catalog application 112 for presentation as page 200.

When available products, mass movers, or hot sellers is selected in pop-up window 230, this results in the selection information being sent to catalog application 112, which then filters the catalog of products at catalog application 112 to yield hot sellers, mass movers, and/or available products. Products that do not have stock available to promise are filtered out of the catalog selected (available products, mass movers and/or hot sellers) by catalog application 112 and are not included in the corresponding catalog.

Selecting mass movers 242 in pop-up window 230 causes catalog application 112 to filter the catalog of products to remove products that do not meet or exceed the threshold number of units sold to be considered a mass mover or do not have stock available to promise. What remains after the filtering by catalog application 112 based on mass movers are products that have sold more units than the mass mover sales threshold value and have stock available to promise to a customer.

FIG. 3 depicts a page 300 presented at a user interface of mobile station 110. The description of FIG. 3 also refers to FIGS. 1 and 2. The page 300 depicts hot sellers 310-318 and product details 320.

For example, selecting hot sellers 244 in pop-up window 230 (FIG. 2) causes catalog application 112 to filter the catalog of products to remove products that do not meet or exceed the threshold value of sales rate to be considered a hot seller or do not have stock available to promise. Remaining after the filtering by catalog application 112 based on hot sellers are products that have a sales rate meeting or exceeding the sales rate threshold value and have stock available to promise to a customer. Page 300 depicts the hot sellers. Although not shown in FIG. 3, hot sellers may be ranked based on their sales rate. For example, the hot seller with the highest sales rate in a category such as accessories 305 may be listed first at 310. The hot seller with the next highest sales rate may be listed second at 312. The hot seller with the next highest sales rate may be listed third at 314, followed by 316, and so on. In another category, for example, bags 307, the hot seller with the highest sales rate 318 may be listed first, and so on. In some implementations, the sales rate ranking may be categorized by a number of stars in the upper left hand corner. For example, each of the hot sellers 310-318 may have a single star 310A-318A indicating that each is in the same sales rate category. Products in categories with higher or lower sales rates may have more or fewer stars.

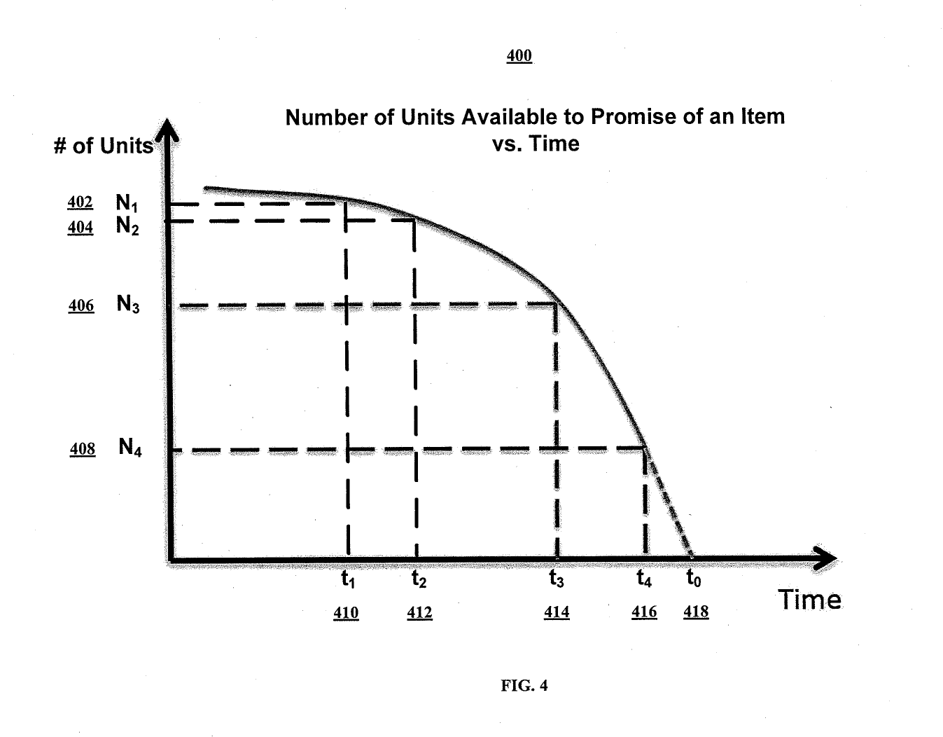

FIG. 4 depicts a plot 400 used as an example to illustrate the process of adjusting a time interval between updates of available stock from inventory tracker 192 of a product at the catalog application 112. The description of FIG. 4 also refers to FIG. 1.

For example, the stock available to promise of one or more products in the catalog may be stale. Up to date data on the stock of a product that is available to promise to a customer is important to reduce back orders and to enable the completion of sales and delivery transactions.

In this example, at time t₁ (410), the stock of product A available to promise is N₁ (402) as indicated by inventory tracker 192 to catalog application 112. At the next update at catalog application 112, t₂ (412), the stock available is N₂ (404), a slightly smaller value than N₁. Because the sales rate is low (the slope of the plot of stock available versus. time is small) and the stock available is sufficient, the time interval before the next update can be lengthened (time between t₂ and t₃ can be greater than the time between t₁ and t₂). Updates by catalog application 112 may be performed by querying inventory tracker 192. In the example of FIG. 4, the interval is lengthened by catalog application 112 from (t₂−t₁) to (t₃−t₂) where (t₃−t₂)>(t₂−t₁). At t₃ (414), the available stock as tracked by catalog application 112 has decreased at an increased rate (increased slope magnitude) to N₄ (408). Accordingly, the time between t₃ (414) and t₄ (416) should be less than the previous interval [(t₄−t₃)<(t₃−t₂)]. At t₄ (416), the stock is getting low and estimating when the available stock is expected to drop to zero may be useful. Time, t₀ (418), when the available stock is expected to be zero, is estimated by extrapolating the available stock to zero based on the sales rate at t₄ to find t₀. Linear interpolation or any other curve fitting technique may be used to model the available stock as a function of time.

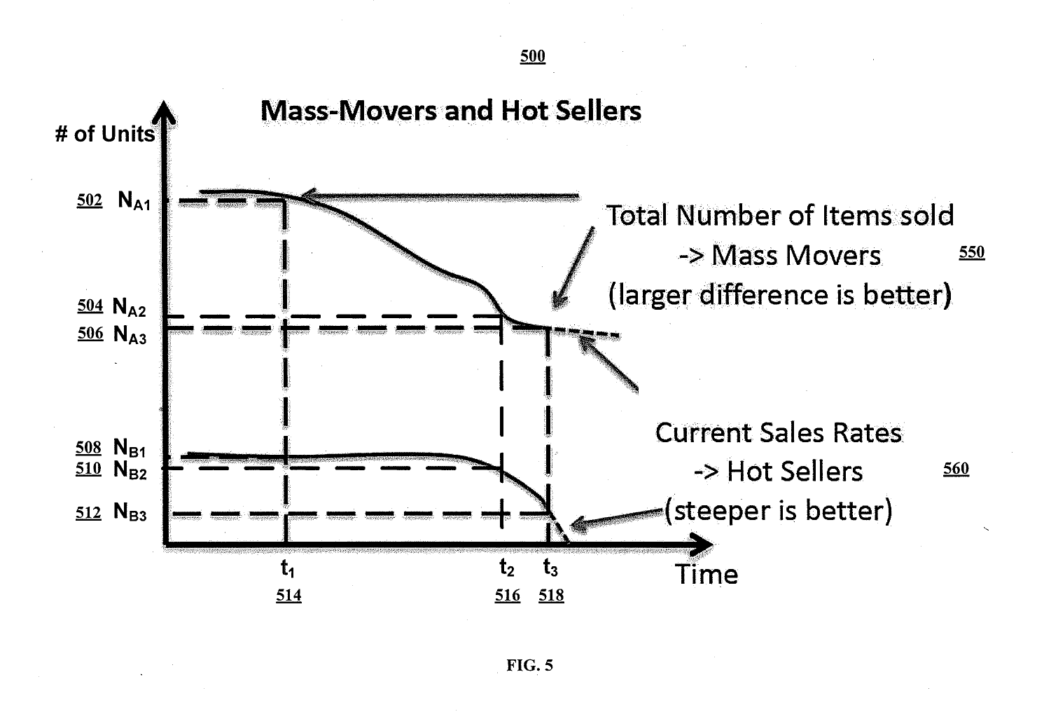

FIG. 5 depicts an example of available stock of two products, A and B, over a period of time used to determine mass movers and hot sellers. In the example of FIG. 5, at time t₁ (514), the stock of product A available to promise is N_{A}! (502), and the stock of product B is N_{B1} (508). At time t₂ (516), the stock of product A has dropped by a quantity of N_{A1}−N_{A2} and the stock of product B has dropped by a quantity of N_{B1}−N_{B2}. If N_{A1}−N_{A2} meets or exceeds the threshold for a mass mover and N_{B1}−N_{B2} is below the threshold, product A may be included in the available products catalog 114 as a mass mover and product B may not be included as a mass mover. Hot sellers may be determined by calculating the sales rate of the products in the available products catalog. In the example of FIG. 5, the sales rate of product A at t₃ (518) can be estimated as (N_{A2}−N_{A3})/(t₃−t₂) and the rate of sales of product B can be estimated as (N_{B2}−N_{B3})/(t₃−t₂). In the example of FIG. 5, the sales rate of product B is greater than the sales rate of product A because (N_{B2}−N_{B3})/(t₃−t₂)>(N_{A2}−N_{A3})/(t₃−t₂). If product B meets or exceeds a threshold for a hot seller and product A does not, product B may be included in the available products catalog as a hot seller, and product A may not be included as a hot seller.

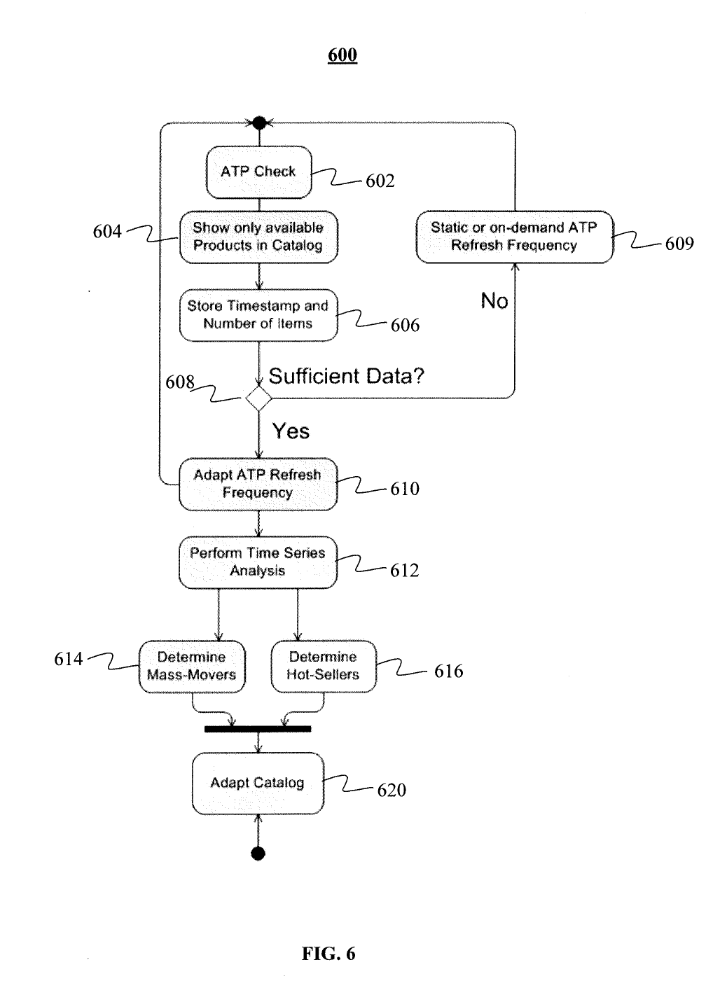

FIG. 6 depicts process 600 used in some implementations. The description of FIG. 6 also refers to FIG. 1. The process may be implemented in an application of a mobile station 110 such as catalog application 112 and initiated by a sales agent at the mobile station via user input at a user interface as described above to determine the products that are available to promise to a customer. A catalog of products whether or not they are available is included as part of the catalog application 112.

At 602, an available to promise check may be performed. For example, catalog application 112 may query inventory tracker 192 for stock available to promise information to update or generate available products catalog 114. The query may be sent as a message through wireless access point 116 and network 160. When the query is received, inventory tracker 192 may query database 196 for available to promise information, such as stock that is available to promise for a given customer or a given product or group of products. When the database responds, inventory tracker 192 may then send the stock available to promise information to catalog application 112. The stock available to promise information may identify stock that is available to promise and/or a time stamp indicating the time the stock was updated in available products catalog 114. For example, the time stamp may represent when the inventory tracker 192 sends the stock available to promise information to catalog application 112.

At 604, the catalog of products may be filtered. For example, catalog application 112 may filter the catalog of products, so that only products that are available to promise are presented to a user at for example user interface 200 or 300.

At 606, time stamps and products may be stored. For example, catalog application 112 may store a quantity of items for a given product that is available to promise and a time stamp. The time stamp may correspond to a time when an update of the available products at available products catalog 114 occurred (e.g., when inventory tracker 192 sends the available to promise information as noted at 602).

At 608, the number of data points collected (each data point having a number of items and a time stamp) is evaluated to decide if sufficient data has been collected to determine mass movers and hot sellers. A minimum of two data points are required with the quality of the determination increasing with additional data points. If at least two data points have been collected, the process continues to 610. If not, the process continues to 609.

At 609, a static available to promise update or an on-demand available to promise update is selected. Catalog application 112 selects which update process will be used. In a static available to promise update, the available to promise information is updated at a fixed frequency (e.g. every hour). This leads to a greater system (communication and processing) load but a faster accumulation of data points. With an on-demand available to promise update, the next update is performed the next time process 600 is repeated. In the time between on-demand updates enough sales of the product may have occurred (e.g. by other sales representatives) to determine mass movers and hot sellers.

If sufficient data has been accumulated at catalog application 112 from inventory tracker 192 at 610, the available to promise refresh (or, e.g., update) frequency (e.g., time interval=1/(frequency)) may be updated by catalog application 112 as described above in relation to FIGS. 1 and 4. For example, if the process illustrated with FIG. 4 determines that the stock level is high and/or the sales rate is low, the time interval between the last update and the next update may be lengthened as described above with respect to FIG. 4. If the sales rate is high and/or the stock is low, the interval between the last update and the next update may be shortened as described above with respect to FIG. 4.

At 612, a time series analysis may be performed. For example, catalog application 112 may analyze the stock update data and time stamps to determine mass movers 614 and hot sellers 616 as described above in relation to FIGS. 1 and 5, although other ways may be used to determine the mass movers and/or hot sellers.

At 620, the available products catalog 114 may be adapted. For example, catalog application 112 may adapt the available products catalog by updating the lists of mass movers and hot sellers, and any associated pages. The updated lists of mass movers and hot sellers may be updated at pages, such as pages 200 and 300, presented at a user interface of a mobile station 110.

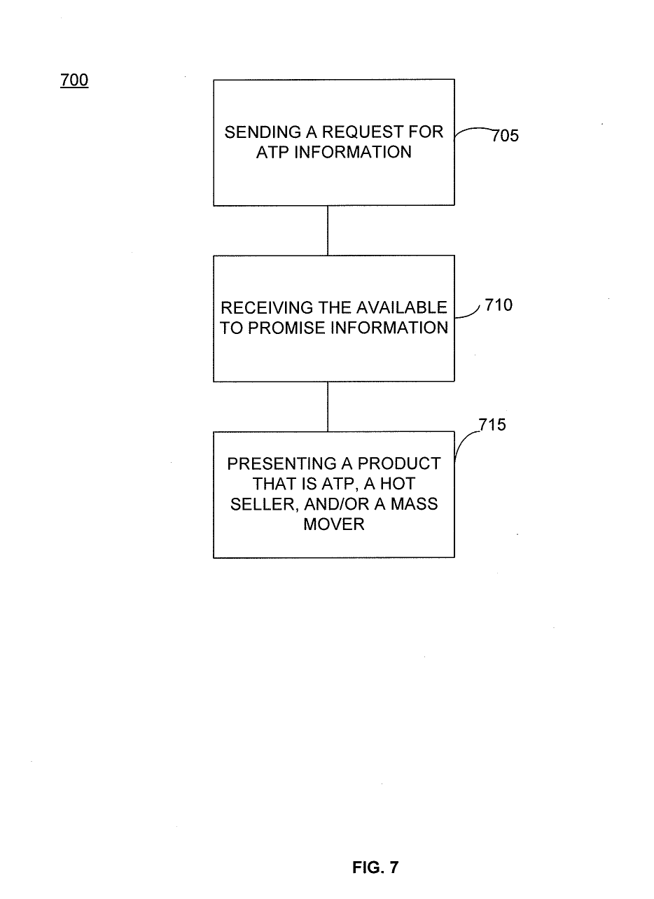

FIG. 7 depicts an exemplary process for determining products which are available to promise, hot sellers, and/or mass movers. At 705, a mobile wireless device may sending a request to a server and/or database for available to promise information for one or more products. At 710, the mobile wireless device may receive the received available to promise information. At 715, the mobile wireless device may present, based on the received available to promise information, at least one of a first product information and a second product information, the first product information representative of a first product having a sales volume exceeding a sales volume threshold, the second product information representative of a second product having a sales rate exceeding a sales rate threshold.

The subject matter described herein may be embodied in systems, apparatus, methods, and/or articles depending on the desired configuration. For example, the mobile station (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the phrase “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. In various example implementations, the methods (or processes) can be accomplished on mobile station/mobile device side or on the server side or in any shared way between server and user equipment/mobile device with actions being performed on both sides. The phrases “based on” and “based on at least” are used interchangeably herein. Other implementations may be within the scope of the following claims.

What is claimed:

1. A method comprising:
sending, from a mobile wireless device, a request for available to promise information;
receiving, at the mobile wireless device, the requested available to promise information; and
presenting, based on the received available to promise information, at least one of a first product information and a second product information, the first product information representative of a first product having a sales volume exceeding a sales volume threshold, the second product information representative of a second product having a sales rate exceeding a sales rate threshold.

2. The method of claim 1, wherein the receiving further comprises:
updating available to promise information at the mobile wireless device, wherein a time interval between a first update and a second update is based on a quantity of available stock and a sales rate.

3. The method of claim 1, wherein the first product comprise a mass mover, and the second product comprises a hot seller.

4. The method of claim 3, further comprising:
determining the mass mover by selecting products with the sales volume greater than the sales volume threshold.

5. The method of claim 3, further comprising:
determining the hot seller by selecting products with the sales rate greater than the sales rate threshold.

6. The method of claim 1, wherein the received available to promise information comprises information about one or more products, the information including one or more of the following: a number of items in stock for each of the one or more products, a pricing for the one or more products, an availability of the one or more products, a past order for the one or more products, and a pending order for the one or more products.

7. A system comprising;
at least one processor; and
at least one memory including code which when executed by the at least one processor provides operations comprising:
sending, from a mobile wireless device, a request for available to promise information;
receiving, at the mobile wireless device, the requested available to promise information; and
presenting, based on the received available to promise information, at least one of a first product information and a second product information, the first product information representative of a first product having a sales volume exceeding a sales volume threshold, the second product information representative of a second product having a sales rate exceeding a sales rate threshold.

8. The system of claim 7, wherein the receiving further comprises:
updating available to promise information at the mobile wireless device, wherein a time interval between a first update and a second update is based on a quantity of available stock and a sales rate.

9. The system of claim 7, wherein the first product comprise a mass mover, and the second product comprises a hot seller.

10. The system of claim 9, further comprising:
determining the mass mover by selecting product information with the sales volume greater than the sales volume threshold.

11. The system of claim 9, further comprising:
determining the hot seller by selecting product information with the sales rate greater than the sales rate threshold.

12. The system of claim 7, wherein the received available to promise information comprises information about one or more products, the information including one or more of the following: a number of items in stock for each of the one or more products, a pricing for the one or more products, an availability of the one or more products, a past order for the one or more products, and a pending order for the one or more products.

13. A non-transitory computer-readable medium including code which when executed by at least one processor provides operations comprising:
sending, from a mobile wireless device, a request for available to promise information;
receiving, at the mobile wireless device, the requested available to promise information; and
presenting, based on the received available to promise information, at least one of a first product information and a second product information, the first product information representative of a first product having a sales volume exceeding a sales volume threshold, the second product information representative of a second product having a sales rate exceeding a sales rate threshold.

14. The non-transitory computer-readable medium of claim 13, wherein the receiving further comprises:
updating available to promise information at the mobile wireless device, wherein a time interval between a first update and a second update is based on a quantity of available stock and a sales rate.

15. The non-transitory computer-readable medium of claim 13, wherein the first product comprise a mass mover, and the second product comprises a hot seller.

16. The non-transitory computer-readable medium of claim 15, further comprising:
determining the mass mover by selecting products with the sales volume greater than the sales volume threshold.

17. The non-transitory computer-readable medium of claim 15, further comprising:
determining the hot seller by selecting products with the sales rate greater than the sales rate threshold.

18. The non-transitory computer-readable medium of claim 13, wherein the received available to promise information comprises information about one or more products, the information including one or more of the following: a number of items in stock for each of the one or more products, a pricing for the one or more products, an availability of the one or more products, a past order for the one or more products, and a pending order for the one or more products.
